(19) United States
(12) Patent Application Publication
(10) Pub. No.: US 2010/0009218 A1
(43) Pub. Date: Jan. 14, 2010

(54) RUTHENIUM (Ru)/RUTHENIUM OXIDE (RuOx) DOPING OF GRAIN BOUNDARIES OF GRANULAR RECORDING MEDIA FOR ENHANCED CORROSION RESISTANCE/GREATER ADHESION

(75) Inventors: Jeffrey Shane Reiter, Palo Alto, CA (US); Steven Eric Barlow, Hayward, CA (US)

Correspondence Address: Shumaker & Sieffert, P.A., 1625 Radio Drive, Suite 300, Woodbury, MN, 55125, US

(73) Assignee: Seagate Technology LLC, Scotts Valley, CA (US)

(21) Appl. No.: 12/169,615

(22) Filed: Jul. 8, 2008

(51) Int. Cl. G11B 5/66

(52) U.S. Cl. 428/829; 428/832; 428/827; 428/831; 428/831.2; 427/132; 427/128

(57) ABSTRACT

The invention relates to a perpendicular magnetic recording medium comprising a substrate and a granular magnetic layer comprising ruthenium or ruthenium oxide in the grain boundaries.

### BACKGROUND

Magnetic thin-film media, wherein a fine grained polycrystalline magnetic alloy layer serves as the active recording medium layer, are generally classified as “longitudinal” or “perpendicular,” depending on the orientation of the magnetization of the magnetic domains of the grains of the magnetic material. In longitudinal media (also often referred as “conventional” media), the magnetization in the bits is flipped between lying parallel and anti-parallel to the direction in which the head is moving relative to the disc.

Perpendicular magnetic recording media are being developed for higher density recording as compared to longitudinal media. The thin-film perpendicular magnetic recording medium comprises a substrate and a magnetic layer having perpendicular magnetic anisotropy. In perpendicular media, the magnetization of the disc, instead of lying in the disc's plane as it does in longitudinal recording, stands on end perpendicular to the plane of the disc. The bits are then represented as regions of upward or downward directed magnetization (corresponding to the 1's and 0's of the digital data).

FIG. 1 shows a disk recording medium and a cross section of a disc showing the difference between longitudinal and perpendicular magnetic recording. Even though FIG. 1 shows one side of the disk, magnetic recording layers are usually sputter deposited on both sides of the non-magnetic aluminum substrate of FIG. 1. Also, even though FIG. 1 shows an aluminum substrate, other embodiments include a substrate made of glass, glass-ceramic, aluminum/NiP, metal alloys, plastic/polymer material, ceramic, glass-polymer, composite materials or other non-magnetic materials.

While perpendicular media technology provides higher areal density capability over longitudinal media, granular perpendicular magnetic recording media is being developed for further extending the areal density as compared to conventional (non-granular) perpendicular magnetic recording which is limited by the existence of strong lateral exchange coupling between magnetic grains. Granular structure provides better grain isolation through oxide segregation to grain boundary, hence enhancing grain to grain magnetic decoupling and increasing media signal to noise ratio (SNR).

A granular perpendicular magnetic layer contains magnetic columnar grains separated by grain boundaries comprising a dielectric material such as oxides, nitrides or carbides to decouple the magnetic grains. The grain boundaries having a thickness of about 2 Å to about 30 Å, provide a substantial reduction in the magnetic interaction between the magnetic grains. In contrast to conventional perpendicular media, wherein the longitudinal magnetic layer is typically sputtered at low pressures and high temperatures in the presence of an inert gas, such as argon (Ar), deposition of the granular perpendicular magnetic layer is conducted at relatively high pressures and low temperatures and utilizes a reactive sputtering technique wherein oxygen (O₂), CₓH_{y}, and/or nitrogen (N₂) are introduced in a gas mixture of, for example, Ar and O₂, Ar and CₓH_{y}, Ar and N₂, or Ar and O₂, CₓH_{y}, and N₂. Alternatively, oxide, carbide or nitrides may be introduced by utilizing a sputter target comprising oxides, carbides and/or nitrides which is sputtered in the presence of an inert gas (e.g., Ar), or, optionally, may be sputtered in the presence of a sputtering gas comprising O₂, CₓH_{y}, and/or N₂ with or without the presence of an inert gas. Not wishing to be bound by theory, the introduction of O₂, CₓH_{y} and/or N₂ reactive gases, and oxides, carbides, and/or nitrides inside targets provides oxides, carbides, and/or nitrides that migrate into the grain boundaries, thereby providing a granular perpendicular structure having a reduced lateral exchange coupling between grains.

FIG. 2 illustrates a granular perpendicular magnetic recording medium design. However, this kind of design suffers from difficulties in obtaining good durability and corrosion resistance. Large quantities of oxygen and chromium are present in granular media making a cap layer insufficient to disrupt the mechanisms of corrosion.

On the other hand, even though a longitudinal recording medium typically has a lower areal density than a granular perpendicular magnetic recording medium, it is substantially free of the defects of the granular perpendicular magnetic recording medium mentioned above. This there is a need to develop a magnetic recording medium having perpendicular anisotropy, yet being substantially free of the defects of the granular perpendicular magnetic recording medium.

### SUMMARY

This invention relates to a perpendicular magnetic recording medium comprising a substrate and a granular magnetic layer comprising ruthenium or ruthenium oxide in the grain boundaries. In one variation, the recording medium further comprises one or more non-oxide containing magnetic layers deposited on a surface of the granular magnetic layer. Preferably, the one or more non-oxide containing magnetic layers are deposited directly on top of the granular magnetic layer.

The granular magnetic layer may comprise a dielectric material at a grain boundary. Preferably, the dielectric material is selected from the group consisting of an oxide, carbide, carbon, a nitride and combinations thereof.

Preferably, the granular magnetic layer comprises Co_{100-x-y-z}Ptₓ(X)_{y}(MO)_{z}, wherein X comprises Cr; MO is an oxide; and ranges of x, y and z are: 1≦x≦30, 0≦y≦30 and 1≦z≦30. Preferably, MO is selected from the group consisting of SiO₂, TiO₂, Nb₂O₅, WO₃, Al₂O₃, and combinations thereof. Preferably, the one or more non-oxide containing magnetic layers comprise Co_{100-x-y-z-α}CrₓPt_{y}B_{z} X_{α}, wherein X is an optional additive selected from the group consisting of Cu, Au, Ta, V and combinations thereof, and ranges of x, y, z and α are: 0≦x≦30, 0≦y≦30, 0≦z≦30, 0≦α≦10.

The one or more non-oxide containing magnetic layers may comprise a grain boundary that is thinner than the grain boundary of the granular magnetic layer. Furthermore, the one or more non-oxide containing magnetic layers may comprise a grain boundary that is denser than the grain boundary of the granular magnetic layer. Preferably, the grain boundary of the one or more non-oxide containing magnetic layers comprise a material selected from the group consisting of Co, Pt, Cr, B and combinations thereof.

In one variation, the recording medium could further comprise a soft underlayer between the substrate and the granular magnetic layer. In another variations, the recording medium could further comprise a seedlayer and/or interlayer that grow the granular magnetic layer in a Co (00.2) orientation. Yet other variations could further comprise a cap layer and carbon-containing overcoat, and lubricant layer.

Another embodiment is a method of manufacturing a perpendicular magnetic recording medium comprising depositing a granular magnetic layer on a substrate, wherein grain boundaries of the granular magnetic layer comprise ruthenium or ruthenium oxide. In one variation, the grain boundaries of the granular magnetic layer are doped with ruthenium or ruthenium oxide.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 schematically shows a magnetic disk recording medium comparing longitudinal and perpendicular magnetic recording.

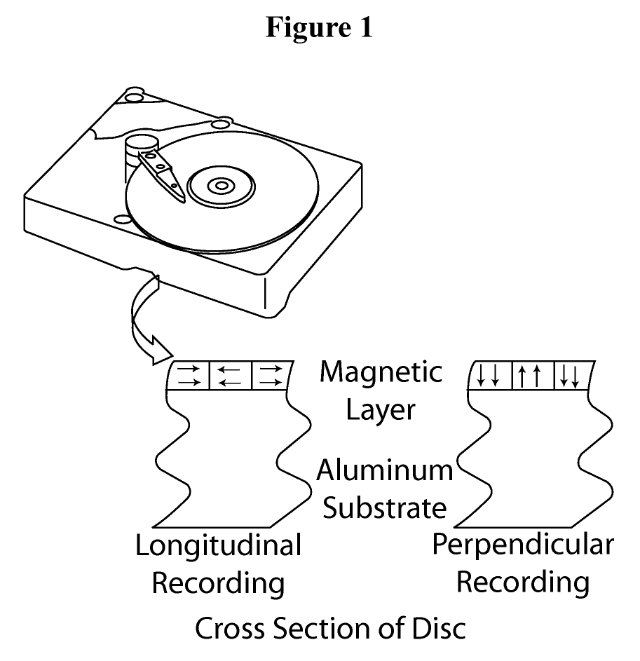

FIG. 2 shows a granular perpendicular magnetic recording medium.

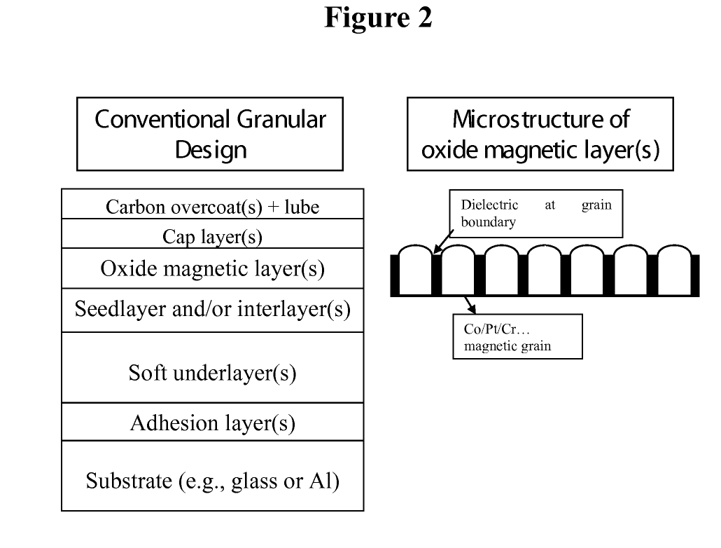

FIG. 3 shows a novel perpendicular magnetic recording medium according to an embodiment of this invention.

### DETAILED DESCRIPTION

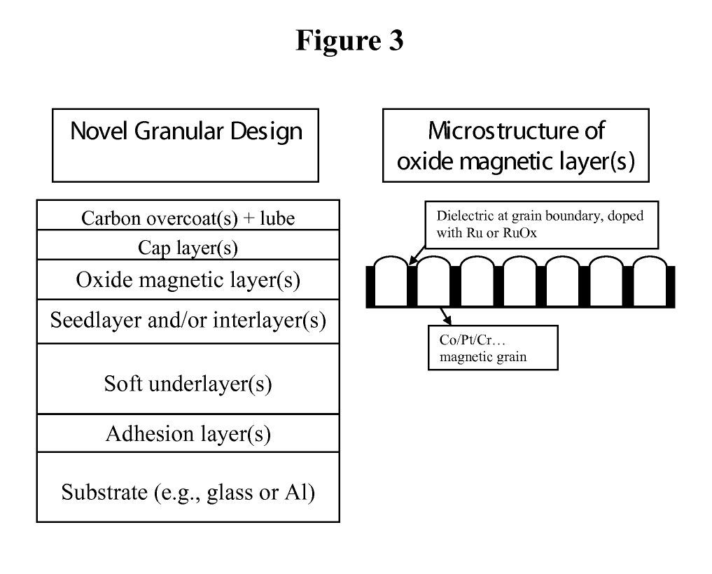

This invention relates to a perpendicular magnetic recording medium having a substrate, soft underlayer(s), seed layer(s), interlayer(s), and a granular magnetic recording layer comprising ruthenium or ruthenium oxide in the grain boundaries. FIG. 3 is an embodiment of this invention showing a perpendicular magnetic recording medium having a granular magnetic recording layer comprising ruthenium or ruthenium oxide in the grain boundaries.

An embodiment of the media comprises, from the bottom to the top:
(1) Substrate: polished glass, glass ceramics, or Al/NiP.
(2) Adhesion layers to ensure strong attachment of the functional layers to the substrates. One can have more than one layer for better adhesion or skip this layer if adhesion is fine. The examples include Ti alloys.
(3) Soft underlayers (SUL) include various design types, including a single SUL, anti-ferromagnetic coupled (AFC) structure, laminated SUL, SUL with pinned layer (also called anti-ferromagnetic exchange biased layer), and so on. The examples of SUL materials include FeₓCo_{y}B_{z} based, and CoₓZr_{y}Nb_{z}/CoₓZr_{y}Ta_{z} based series.
(4) Seed layer(s) and interlayer(s) are the template for Co (00.2) growth. Examples are RuX series of materials.
(5) Granular magnetic recording layer(s) can be sputtered with conventional granular media targets reactively (with Oₓ) and/or non-reactively. Multiple layers can be employed to achieve desired film property and performance. Examples of targets are Co_{100-x-y}Ptₓ(MO)_{y} and/or Co_{100-x-y-z}Ptₓ(X)_{y}(MO)_{z} series (X is the 3^{id} additives such as Cr, and M is metal elements such as Si, Ti and Nb). Besides oxides, the magnetic grains in the layer can be isolated from each other with dielectric materials at grain boundary, such as nitrides (MₓN_{y}), carbon (C) and carbides (MₓC_{y}). The examples of sputter targets are Co_{100-x-y}Ptₓ(MN)_{y}, Co_{100-x-y}Ptₓ(MC)_{y} and/or Co_{100-x-y-z}Ptₓ(X)_{y}(MN)_{z}, Co_{100-x-y-z}Ptₓ(X)_{y}(MC)_{z} series. The grain boundaries of the granular magnetic recording layer(s) according to the invention comprise ruthenium or ruthenium oxide.
(6) Optional Non-oxide containing magnetic layers: Single layer or multiple layers can be sputtered on the top of the granular magnetic layers. The non-oxide magnetic layer(s) will grow epitaxially from oxide granular layer underneath. The orientation could eventually change if these layers are too thick. The examples of these are Co_{100-x-y-z-α}CrₓPt_{y}B_{z} X_{α} Y_{β}.
(7) Cap layer, which is optional for this design. In one variation, with dense grains and grain boundary without oxygen may not be necessary. Conventional carbon and lubrication can be adapted for the embodiment of the claimed media to achieve adequate mechanical performance.

The above layered structure of an embodiment is an exemplary structure. In other embodiments, the layered structure could be different with either less or more layers than those stated above.

Instead of the optional NiP coating on the substrate, the layer on the substrate could be any Ni-containing layer such as a NiNb layer, a Cr/NiNb layer, or any other Ni-containing layer. Optionally, there could be an adhesion layer between the substrate and the Ni-containing layer. The surface of the Ni-containing layer could be optionally oxidized.

The substrates used can be Al alloy, glass, or glass-ceramic. The magnetically soft underlayers according to present invention are amorphous or nanocrystalline and can be FeCoB, FeCoC,FeCoTaZr, FeTaC, FeSi, CoZrNb, CoZrTa, etc. The seed layers and interlayer can be Cu, Ag, Au, Pt, Pd, Ru-alloy, etc. The CoPt-based magnetic recording layer can be CoPt, CoPtCr, CoPtCrTa, CoPtCrB, CoPtCrNb, CoPtTi, CoPtCrTi, CoPtCrSi, CoPtCrAl, CoPtCrZr, CoPtCrHf, CoPtCrW, CoPtCrC, CoPtCrMo, CoPtCrRu, etc., deposited under argon gas, or under a gas mixture of argon and oxygen or nitrogen. Dielectric materials such as oxides, carbides or nitrides can be incorporated into the target materials also.

Embodiments of this invention include the use of any of the various magnetic alloys containing Pt and Co, and other combinations of B, Cr, Co, Pt, Ni, Al, Si, Zr, Hf, W, C, Mo, Ru, Ta, Nb, O and N, in the magnetic recording layer.

In a preferred embodiment the total thickness of SUL could be 100 to 5000 Å, and more preferably 600 to 2000 Å. There could be a more than one soft under layer. The laminations of the SUL can have identical thickness or different thickness. The spacer layers between the laminations of SUL could be Ta, C, etc. with thickness between 1 and 50 Å. The thickness of the seed layer, tₛ, could be in the range of 1 Å<tₛ<50 Å. The thickness of an intermediate layer could be 10 to 500 Å, and more preferably 100 to 300 Å. The thickness of the magnetic recording layer is about 50 Å to about 300 Å, more preferably 80 to 150 Å. The adhesion enhancement layer could be Ti, TiCr, Cr etc. with thickness of 10 to 50 Å. The overcoat cap layer could be hydrogenated, nitrogenated, hybrid or other forms of carbon with thickness of 10 to 80 Å, and more preferably 20 to 60 Å.

The magnetic recording medium has a remanent coercivity of about 2000 to about 10,000 Oersted, and an Mᵣt (product of remanance, Mr, and magnetic recording layer thickness, t) of about 0.2 to about 2.0 memu/cm². In a preferred embodiment, the coercivity is about 2500 to about 9000 Oersted, more preferably in the range of about 4000 to about 8000 Oersted, and most preferably in the range of about 4000 to about 7000 Oersted. In a preferred embodiment, the Mᵣt is about 0.25 to about 1 memu/cm², more preferably in the range of about 0.4 to about 0.9 memu/cm².

Almost all the manufacturing of a disk media takes place in clean rooms where the amount of dust in the atmosphere is kept very low, and is strictly controlled and monitored. After one or more cleaning processes on a non-magnetic substrate, the substrate has an ultra-clean surface and is ready for the deposition of layers of magnetic media on the substrate. The apparatus for depositing all the layers needed for such media could be a static sputter system or a pass-by system, where all the layers except the lubricant are deposited sequentially inside a suitable vacuum environment.

Each of the layers constituting magnetic recording media of the present invention, except for a carbon overcoat and a lubricant topcoat layer, may be deposited or otherwise formed by any suitable physical vapor deposition technique (PVD), e.g., sputtering, or by a combination of PVD techniques, i.e., sputtering, vacuum evaporation, etc., with sputtering being preferred. The carbon overcoat is typically deposited with sputtering or ion beam deposition. The lubricant layer is typically provided as a topcoat by dipping of the medium into a bath containing a solution of the lubricant compound, followed by removal of excess liquid, as by wiping, or by a vapor lube deposition method in a vacuum environment.

Sputtering is perhaps the most important step in the whole process of creating recording media. There are two types of sputtering: pass-by sputtering and static sputtering. In pass-by sputtering, disks are passed inside a vacuum chamber, where they are deposited with the magnetic and non-magnetic materials that are deposited as one or more layers on the substrate when the disks are moving. Static sputtering uses smaller machines, and each disk is picked up and deposited individually when the disks are not moving. The layers on the disk of the embodiment of this invention were deposited by static sputtering in a sputter machine.

The sputtered layers are deposited in what are called bombs, which are loaded onto the sputtering machine. The bombs are vacuum chambers with targets on either side. The substrate is lifted into the bomb and is deposited with the sputtered material.

A layer of lube is preferably applied to the carbon surface as one of the topcoat layers on the disk.

Sputtering leads to some particulates formation on the post sputter disks. These particulates need to be removed to ensure that they do not lead to the scratching between the head and substrate. Once a layer of lube is applied, the substrates move to the buffing stage, where the substrate is polished while it preferentially spins around a spindle. The disk is wiped and a clean lube is evenly applied on the surface.

Subsequently, in some cases, the disk is prepared and tested for quality thorough a three-stage process. First, a burnishing head passes over the surface, removing any bumps (asperities as the technical term goes). The glide head then goes over the disk, checking for remaining bumps, if any. Finally the certifying head checks the surface for manufacturing defects and also measures the magnetic recording ability of the disk.

This application discloses several numerical ranges in the text and figures. The numerical ranges disclosed support any range or value within the disclosed numerical ranges even though a precise range limitation is not stated verbatim in the specification because this invention can be practiced throughout the disclosed numerical ranges. In the claims, the terms “a” and “an” mean one or more.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

The implementations described above and other implementations are within the scope of the following claims.

1. A magnetic recording medium, comprising:
a substrate, and
a granular magnetic layer, wherein grain boundaries of the granular magnetic layer comprise ruthenium or ruthenium oxide.

2. The magnetic recording medium of claim 1, wherein the grain boundaries further comprise a dielectric material is selected from the group consisting of an oxide, carbide, carbon, a nitride and combinations thereof.

3. The magnetic recording medium of claim 1, wherein the granular magnetic layer comprises multiple magnetic layers.

4. The magnetic recording medium of claim 1, wherein the granular magnetic layer comprises Co_{100-x-y-z}Ptₓ(X)_{y}(MO)_{z}, wherein X comprises Cr; MO is an oxide; and ranges of x, y and z are: 1≦x≦30, 0≦y≦30 and 1≦z≦30.

5. The magnetic recording medium of claim 4, wherein MO is selected from the group consisting of SiO₂, TiO₂, Nb₂O₅, WO₃, Al₂O₃, and combinations thereof.

6. The magnetic recording medium of claim 1, further comprising one or more non-oxide containing magnetic layers deposited on a surface of the granular magnetic layer.

7. The magnetic recording medium of claim 6, wherein the one or more non-oxide containing magnetic layers comprise a grain boundary that is thinner than the grain boundary of the granular magnetic layer.

8. The magnetic recording medium of claim 6, wherein the one or more non-oxide containing magnetic layers comprise Co_{100-x-y-z-α}CrₓPt_{y}B_{z} X_{α}, wherein X is an optional additive selected from the group consisting of Cu, Au, Ta, V and combinations thereof, and ranges of x, y, z and α are: 0≦x≦30, 0≦y≦30, 0≦z≦30, 0≦α≦10.

9. The magnetic recording medium of claim 1, wherein the one or more non-oxide containing magnetic layers comprise a grain boundary that is denser than the grain boundary of the granular magnetic layer.

10. The magnetic recording medium of claim 9, wherein the grain boundary of the one or more non-oxide containing magnetic layers comprise a material selected from the group consisting of Co, Pt, Cr, B and combinations thereof.

11. The magnetic recording medium of claim 1, further comprising a soft underlayer between the substrate and the granular magnetic layer.

12. The magnetic recording medium of claim 1, further comprising a seedlayer and/or interlayer that grow the granular magnetic layer in a Co (00.2) orientation.

13. The magnetic recording medium of claim 1, further comprising a cap layer, a carbon-containing overcoat, and/or a lubricant layer.

14. The magnetic recording medium of claim 1, wherein the one or more non-oxide containing magnetic layers have a growth orientation that is same as a growth orientation of the granular magnetic layer.

15. A method of manufacturing a magnetic recording medium comprising depositing a granular magnetic layer on a substrate, wherein grain boundaries of the granular magnetic layer comprise ruthenium or ruthenium oxide.

16. The method of claim 15, wherein the grain boundaries of the granular magnetic layer are doped with ruthenium or ruthenium oxide.

17. The method of claim 15, further comprising depositing one or more non-oxide containing magnetic layers on the granular magnetic layer from a target containing substantially no oxide.

18. The method of claim 17, wherein said depositing the granular magnetic layer is in an argon and oxygen containing environment having a pressure of more than 20 mTorr and said depositing the one or more non-oxide containing magnetic layers is in an argon containing environment having substantially no oxygen and having a pressure of less than 20 mTorr.

19. The method of claim 15, wherein the granular magnetic layer is deposited from one or more targets comprising a dielectric.

20. The method of claim 15, further comprising:
depositing a cap layer on the granular magnetic layer, and
depositing a carbon-containing overcoat on the cap layer.
